(19) United States
(12) Patent Application Publication
(10) Pub. No.: US 2021/0358255 A1
(43) Pub. Date: Nov. 18, 2021

(54) SYSTEM AND METHOD FOR DETECTING CURRENCY GENIUNESS

(71) Applicant: Apparao BODDEDA, Visakhapatnam Andhrapradesh (IN)

(72) Inventor: Swarna Kumari Adari, Visakhapatnam (IN)

(21) Appl. No.: 17/056,112

(22) PCT Filed: May 16, 2019
(86) PCT No.: PCT/IB2019/054063

§ 371 Date: Nov. 17, 2020

(30) Foreign Application Priority Data
May 17, 2018 (IN) 201841018501

(51) Int. Cl. G07D 7/00; G07D 7/026; G07D 7/04; G07F 19/00

(52) U.S. Cl. CPC G07D 7/0034; G07F 19/202; G07D 7/04; G07D 7/026

(57) ABSTRACT

The present invention is a system and method to equip the ATM (Automated Teller Machine) with the special hardware to detect the each currency note to determine whether that note is a legal tender or not. The counterfeited currency hardware will work with computer executable instructions to detect counterfeited notes while feeding and dispensing in to and from the ATM machine respectively. The aim of the invention is to negligate the chance of counterfeited currency being fed and dispense from the ATM.

### TECHNICAL FIELD

The present invention relates, in general, to currency identification and more particularly to system and method for detecting and/or rejecting fake or counterfeit currency.

### BACKGROUND

The background description includes information that may be useful in understanding the present invention. It is not an admission that any of the information provided herein is prior art or relevant to the presently claimed invention, or that any publication specifically or implicitly referenced is prior art.

The present invention relates to the examination of bills or other currency for purposes such as determining their authenticity and denomination, and more particularly to methods and apparatus for achieving a high level of acceptance of valid bills or currency while simultaneously maintaining a high level of rejection of non-valid bills or currency, such as counterfeits. While the present invention is applicable to testing of bills and other currency, for the sake of simplicity, the exemplary discussion which follows is primarily in terms of paper currency.

The application of the present invention to the testing of paper money, banknotes and other currency will be immediately apparent to one of ordinary skill in the art.

It has long been recognized in the field of bill and currency testing that a balance must be struck between the conflicting goals of “acceptance” and “rejection”—perfect acceptance being the ability to correctly identify and accept all genuine items no matter their condition, and perfect rejection being the ability to correctly discriminate and reject all non-genuine items. When testing under ideal conditions, no difficulty arises when trying to separate ideal or perfect bills from bills or counterfeit bills that have different characteristics even if those differences are relatively slight. Data identifying the characteristics of the ideal bills can be stored and compared with data measured from a bill or bill to be tested. By narrowly defining bill acceptance criteria, valid bills that produce data falling within these criteria can be accepted and bills that produce data falling outside these criteria can be rejected.

A well-known method for bill acceptance and bill rejection is the use of bill acceptance windows to define criteria for the bill acceptance. Of course, in reality, neither the test conditions nor the bills to be tested are ideal. Windows or other tests must be set up to accept a range of characteristic bill data for worn or damaged genuine bills, and also to compensate for environmental conditions such as extreme heat, extreme cold, humidity and the like. As the acceptance windows or other bill testing criteria are widened or loosened, it becomes more and more likely that a bill or counterfeit bill will be mistakenly accepted as genuine. As test criteria are narrowed or tightened, it becomes more likely that a genuine bill will be rejected.

Under the influences of improving the service efficiency, reducing the service cost and other factors, Automatic Teller Machine (ATM) is applied increasingly deep and broad in the field of financial service. Whether for traditional ATM which fails to provide the service of deposit function or for Cell Switch Router (CSR) widely used in bank halls with self-service deposit and withdrawal function, due to cash flow, moreover, 100% accuracy of the identification capacity for the counterfeit banknotes by the built-in cash-out module of the ATM cannot be ensured, conditions that customers withdraw counterfeit banknotes from ATM, banks receive and keep counterfeit banknotes withdrawn from ATM or counterfeit banknotes fail to be confiscated promptly in spite of being recognized are possibly to occur, thus, causing damage to the society. Upon occurrence of such conditions, customers and/or banks will suffer economic losses and troubles, while legal liabilities of the counterfeit banknote providers fail to be investigated effectively for liability related parties often have their own expressions due to the lack of necessary evidences, even the involvement of the third party for example the court or public security organs, due to the lack of concrete evidences, it would not help.

As shown by an example, an automatic teller machine with anti-counterfeit banknote function as disclosed by published Chinese patent application CN 101504782A features that the counterfeit banknote identification device is set on the banknote output module, and a true and counterfeit banknote separation device is connected to the identification device.

It is well-known that banks do not fill or re-fill the ATM machines. Most of the times, the bank select a third party agency to do this job for them. As the customer and bank officials face problem identifying the counterfeited notes in real-time. This will create problems for both of them as it is difficult to prove for the customer that the counterfeited note is released from that particular bank ATM and also for the bank officials to identify the person who deposited the counterfeited currency to the system and also whether the customer claiming the counterfeited currency withdrawn from the bank ATM is true to its words.

Therefore, there is a need for the solution to negligate the possibility of counterfeit notes in the bank ATM even while depositing or filing the notes in ATM by the third party agencies and withdrawing from the ATM.

It may be appreciated that, while the terms like “fake”, “counterfeit” and “illegal” are used interchangeably throughout the specification, however all these terms technically and logically mean the same in the purview of this disclosure.

### SUMMARY

The present invention is presented to solve the above mentioned problems in the background. The aim of the invention is to equip the ATM with the special hardware to detect the each currency note to determine whether that note is a legal tender or not.

The counterfeited currency hardware can be fitted along with currency dispensing system. So, each note will be checked in the currency chest before dispensing and after that, only legal notes are dispensed to the consumer or customer.

In case of detection of fake or counterfeit currency, the counterfeited currency is separated and put in a different compartment and new legal currency note of same denomination will be dispensed.

In other embodiment, the number of counterfeited notes is collected and bank official can get the count and do necessary actions.

In another embodiment, the counterfeited currency hardware can be fitted in each denomination cash cassette. So, during the filling of the cash in to the cassette of the ATM, the system will check each cassette for every note, when the operator tries to close and lock the cassette. After the successful checking, only then the operator is able to close and lock the ATM machine.

In another embodiment, if the operator is trying to fill the counterfeited notes, then during checking the by any means of alerts like sound, vibration and/or display, it is notified to the operator that the particular denomination cassette is having counterfeited notes.

In another embodiment, the number of counterfeited notes can be displayed on the display on the each cassette along with the number printed on the currency using imaging device fitted with the counterfeited currency detector.

In another embodiment, the imaging device can work as a standalone device or can be part of the special counterfeit currency detector.

The invention is not limited to ATMs only. The invention can also be used in cash collecting machines, Cash depositing machines (CDM).

In another embodiment, using cash collecting machines or cash depositing machine, each note deposited by the customer can be checked and display the total number of note deposited and number of counterfeited notes, if identified. The machine then requests the number of legal notes in place of counterfeited notes to make the deposit to the account. The counterfeited notes are collected in the separate chest. The machine will not return the counterfeited notes to the customer. The bank official, periodically check and destroy such counterfeited notes as per security and banking regulations protocols.

In another embodiment, the process of detection and scanning of each cash chest or cassette goes parallel even when the operator is filling the notes in the chest.

In another embodiment, there is an image capturing device at the device to capture the image of the operator filling the cash and/or customer withdrawing the cash from the ATM and/or adding cash to the CDM (Cash Depositing Machine). The same information is transmitted to the bank server along with ATM ID and location of the ATM for future reference.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

The diagrams are for illustration only, which thus is not a limitation of the present disclosure, and wherein:

FIG. 1 illustrates an exemplary implementation of the proposed invention.

FIG. 2 illustrates an exemplary implementation of the proposed invention and working of the proposed invention.

FIG. 3 illustrates an exemplary currency used in India and its various characteristics.

FIG. 4 illustrates an exemplary device utilized for implementation of the proposed system in accordance with an exemplary embodiment of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure.

Embodiments of the present invention may be provided as a computer program product, which may include a machine-readable storage medium tangibly embodying thereon instructions, which may be used to program a computer (or other electronic devices) to perform a process.

The present invention relates generally to counterfeit notes OR currency in banking system and more particularly to detecting and rejecting fake or counterfeit currency from the ATM.

The aim of the invention is to equip the ATM with the special hardware with supporting computer executable instructions to detect the each currency note to determine whether that note is a legal tender or not.

The counterfeited currency hardware can be fitted along with currency dispensing system. So, each note will be checked in the currency chest before dispensing and after that, only legal notes are dispensed to the consumer or customer.

In case, the fake or counterfeit currency is detected by the system, the counterfeited currency is then separated from the legal tenders and put in a different compartment and new legal currency note of same denomination will be dispensed to the customer.

In other implementation, the number of counterfeited notes is collected and bank official can check the count of the counterfeited notes and take necessary actions.

An aspect of the present disclosure relates to a device for currency genuineness detection. The device can include at least one currency inlet slot, at least one currency exiting slot, and a memory having a set of executable instructions. In an aspect, the execution of said set of instructions by one or more processors causes said one or more processors to scan a currency received at the at least one currency inlet slot to detect genuineness of said scanned currency, and exit said scanned currency through the at least one currency exiting slot if said scanned currency is genuine, or separate said scanned currency into a collector if said scanned currency is not genuine.

In an aspect, device is configured before the dispensing mechanism of a cash withdrawal machine or of an automated cash chest counter. In another aspect, device is configured such that, if said scanned currency is not genuine, the cash withdrawal machine or the automated cash chest counter do not get activated to perform one or more functions.

In an aspect, device includes a plurality of rollers directly connected to a mechanical driving means to turn said rollers functioning to draw said currency through said at least one currency inlet slot and exit through said at least one currency exiting slot.

In an aspect, said genuineness of said scanned currency is detected by scanning a plurality of characteristics associated with said currency, wherein said plurality of scanned characteristics are compared with a pre-determined characteristic of a genuine currency. In another aspect, the pre-determined characteristic of said genuine currency are selected at least from observe through register, optically variable ink (OVI), latent image, identification mark, water mark, intaglio printing, security thread, and micro lettering.

In an aspect, device is capable of scanning all sections on top and bottom of said currency to detect said numbers.

In an aspect, the device is designed specifically to accommodate varying sizes of currency utilized worldwide.

In an aspect, the device functions to convert said numbers into digitized form functioning to increase speed of character recognition.

In an aspect, the device also includes at least one detector selected from the group consisting of: optical, magnetic, electrical conductivity, capacitive, and mechanical sensors, for scanning the received currency.

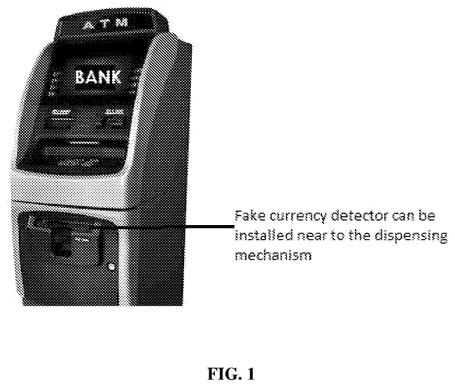

An ATM machine with fake or counterfeited currency detector is shown in FIG. 1. The fake or counterfeit currency detector can be fitted close to the dispensing unit of the ATM. Before dispensing, the counterfeit currency detector hardware checks for every note which is about to dispense. If any note found to be counterfeit, the note will be separated and put to a different compartment and another legal note of same denomination will dispense to the customer.

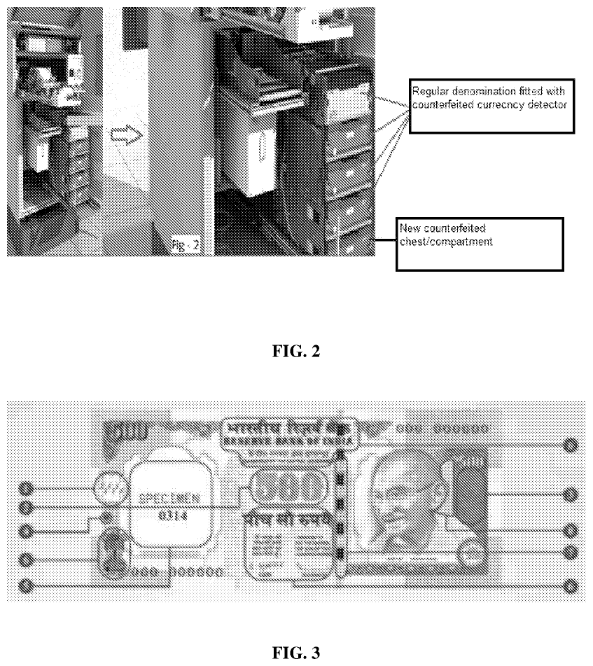

In another embodiment, the counterfeit currency detector can be fitted with every cassette/compartment/chest of ATM. Every cassette/compartment/chest having different denomination of currency as illustrated in FIG. 2.

In another embodiment, a new compartment/chest is introduced to collect the fake or counterfeited currency detected.

While filing the ATM's different cassette or chest, every note is checked for its legality. This process is real-time and the chest will not lock until all the notes have been checked. In this way, no fake or counterfeit note can be put to the any ATM machine. The process will repeat until all the notes are found to be legal.

In case, any note which is not legal is put in the chest, there will be warning or alert signal and the counterfeited notes are collected in the counterfeited chest/compartment automatically.

This counterfeited note chest/compartment will remain locked and can be opened with person with upper security level clearance.

In another embodiment, the counterfeited currency compartment can display the number/count of the notes detected.

In another embodiment, the number of counterfeited notes can be displayed on the display on the cassette along with the currency number printed on the currency using imaging device fitted with the counterfeited currency detector.

Also, the counterfeited currency detector can also have an imaging device, which can capture the operator who is trying to feed/fill the counterfeited notes in the ATM.

The image of the operator will be captured and transmit to the bank server without any information to the operator. This way, the bank official can take necessary steps to avoid such situation in the future as now they have evidence of the person feeding counterfeited notes in the ATM.

In another embodiment, the imaging device can work as a standalone device or can be part of the special counterfeit currency detector or part of the complete ATM machine.

The invention is not limited to ATMs only. The invention can also be used in cash collecting machines, Cash depositing machines (CDM), also with machines which collect paper currency and dispense goods, tokens etc.

An example using cash collecting machines or cash depositing machine, each note deposited by the customer can be checked and display the total number of note deposited and number of counterfeited notes, if identified. The machine then requests the number of legal notes in place of counterfeited notes to make the deposit to the account. The image of the counterfeited currency note is displayed to the customer. The counterfeited notes are collected in the separate chest. The machine will not return the counterfeited notes to the customer. The bank official, periodically check and destroy such counterfeited notes as per security and banking regulations protocols.

In another embodiment, the system and method is intelligent enough to capture the each fake currency note by using internal imaging device while depositing by the each customer and it will be stored in the database and attach to the depositor account. By this, the bank official will get the information of the customer trying to deposit the counterfeited currency. If the pattern repeats, the bank official can take necessary steps.

FIG. 3 illustrates an exemplary currency used in India and its various characteristics. Below provided are few of the characteristics of the currency which may be scanned form the input currency of the device or can be pre-determined by the device to confirm the genuineness of the currency. It may be appreciated that, even though the below characteristics are provided by the way of example, these characteristic shall not restrict the scope of the invention by any way and new or other available features of existing or new currency can also be provided for scanning and determining the genuineness of the currency.

Observe through Register:

The small floral design printed both on the front (hollow) and back (filled up) of the note in the middle of the vertical band next to the Watermark. The design will appear as one floral design when seen against the light.

Optically Variable Ink (OVI):

500 number looks in green color while seen straight. When the note is tilted to certain angle it is seen in blue color. The numeral 1000 and 500 on the obverse of Rs.1000 and Rs.500 notes respectively is printed in optically variable ink viz., a colour-shifting ink. The colour of the numeral 1000/500 appears green when the note is held flat but would change to blue when the note is held at an angle.

Latent Image:

On the obverse side of Rs.1000, Rs.500, Rs.100, Rs.50 and Rs.20 notes, a vertical band on the right side of the Mahatma Gandhi's portrait contains a latent image showing the respective denominational value in numeral. The latent image is visible only when the note is held horizontally at eye level.

Identification Mark:

If we touch circle with intaglio Print we can identify the denomination number. This is useful for the persons with defective eye vision.

Water Mark:

In Obverse side of note, the Mahatma Gandhi Series of banknotes contain the Mahatma Gandhi watermark with a light and shade effect and multi-directional lines in the watermark window.

Intaglio Printing:

The portrait of Mahatma Gandhi, the Reserve Bank seal, guarantee and promise clause, Ashoka Pillar Emblem on the left, RBI Governor's signature are printed in intaglio i.e. in raised prints, which can be felt by touch, in Rs.20, Rs.50, Rs.100, Rs. 500 and Rs. 1000 notes.

Security Thread:

Security thread with 3 mm width having letters ‘Bharat’ in Hindi and RBI seal is present. Color changes from green to blue when seen in different angles. Greenish on the reverse side, florescent text is visible when seen under ultraviolet light. Long line of thread will be visible when seen in light.

Micro Lettering:

This feature appears between the vertical band and Mahatma Gandhi portrait. It contains the word RBI in Rs.5 and Rs.10. The notes of Rs.20 and above also contain the denominational value of the notes in microletters. This feature can be seen better under a magnifying glass.

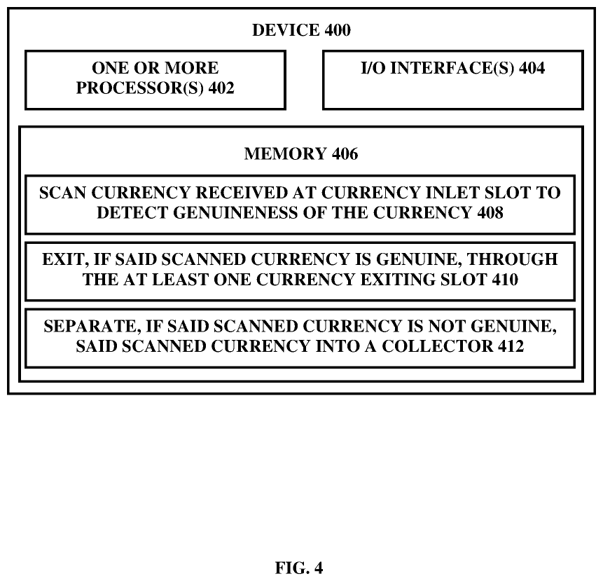

FIG. 4 illustrates an exemplary device utilized for implementation of the proposed system in accordance with an exemplary embodiment of the present disclosure. Although the present subject matter is explained considering that it is implemented as a device 400 which is a regularly interacting or interdependent group of items forming a unified whole, it may be understood that the device may also be implemented in a variety of computing systems, such as a laptop computer, a desktop computer, a notebook, a workstation, a mainframe computer, a server, a network server, and the like. It will be understood that the device may be accessed by multiple users through one or more user devices (not shown), or applications (not shown) residing on the user devices.

In one implementation, the device 400 may include, but are not limited to, routers, bridges, servers, computing devices, storage devices, a portable computer, a personal digital assistant, a handheld device, and a workstation.

In one implementation, the network may be a wireless network, a wired network or a combination thereof. The network can be implemented as one of the different types of networks, such as intranet, local area network (LAN), wide area network (WAN), the Internet, and the like. The network may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network may include a variety of network devices, including routers, bridges, servers, computing devices, storage devices, and the like.

In one embodiment, the device 400 may include one or more processor(s) 402, input/output (I/O) interfaces 404, and a memory 406. The processor(s) 402 may be implemented as one or more microprocessors, microcomputers, microcontrollers, digital signal processors, central processing units, state machines, logic circuitries, and/or any devices that manipulate signals based on operational instructions. Among other capabilities, the at least one processor is configured to fetch and execute computer-readable instructions stored in the memory 406.

The I/O interface(s) 404 may include a variety of software and hardware interfaces, for example, a web interface, a graphical user interface, and the like. The I/O interface may allow the system to interact with a user directly or through the client devices. Further, the I/O interface 404 may enable the device to communicate with other computing devices, such as web servers and external data servers (not shown). The I/O interface can facilitate multiple communications within a wide variety of networks and protocol types, including wired networks, for example, LAN, cable, etc., and wireless networks, such as WLAN, cellular, or satellite. The I/O interface may include one or more ports for connecting a number of devices to one another or to another server.

The memory 406 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory may include modules and data.

The modules include routines, programs, objects, components, data structures, etc., which perform particular tasks or implement particular abstract data types. The data, amongst other things, serves as a repository for storing data processed, received, and generated by one or more of the modules.

In an embodiment, deice 400 having a non-transitory storage device includes embodied therein one or more routines operable to detect genuineness of the currency.

In an embodiment, one of the routines 408 scans a currency received at the at least one currency inlet slot to detect genuineness of said scanned currency.

In an embodiment, one of the routines 410 exits the scanned currency through the at least one currency exiting slot if said scanned currency is genuine.

In an embodiment, one of the routines 412 separates said scanned currency into a collector if said scanned currency is not genuine.

In an exemplary embodiment, device is configured before the dispensing mechanism of a cash withdrawal machine or of an automated cash chest counter. In another exemplary embodiment, device is configured such that, if said scanned currency is not genuine, the cash withdrawal machine or the automated cash chest counter do not get activated to perform one or more functions.

In an exemplary embodiment, device includes a plurality of rollers directly connected to a mechanical driving means to turn said rollers functioning to draw said currency through said at least one currency inlet slot and exit through said at least one currency exiting slot.

In an exemplary embodiment, said genuineness of said scanned currency is detected by scanning a plurality of characteristics associated with said currency, wherein said plurality of scanned characteristics are compared with a pre-determined characteristic of a genuine currency. In another aspect, the pre-determined characteristic of said genuine currency are selected at least from observe through register, optically variable ink (OVI), latent image, identification mark, water mark, intaglio printing, security thread, and micro lettering.

In an exemplary embodiment, device is capable of scanning all sections on top and bottom of said currency to detect said numbers.

In an exemplary embodiment, the device is designed specifically to accommodate varying sizes of currency utilized worldwide.

In an exemplary embodiment, the device functions to convert said numbers into digitized form functioning to increase speed of character recognition.

In an exemplary embodiment, the device also includes at least one detector selected from the group consisting of: optical, magnetic, electrical conductivity, capacitive, and mechanical sensors, for scanning the received currency.

In an exemplary embodiment, the process of detection and scanning of each cash chest or cassette goes parallel even when the operator is filling the notes in the chest.

In an exemplary embodiment, there is an image capturing device at the device to capture the image of the operator filling the cash and/or customer withdrawing the cash from the ATM and/or adding cash to the CDM (Cash Depositing Machine). The same information is transmitted to the bank server along with ATM ID and location of the ATM for future reference.

Having described several embodiments, it will be recognized by those of skill in the art that various modifications, alternative constructions, and equivalents may be used without departing from the spirit of the invention. Additionally, a number of well-known processes and elements have not been described in order to avoid unnecessarily obscuring the present invention.

Accordingly, the above description should not be taken as limiting the scope of the invention.

While the foregoing describes various embodiments of the invention, other and further embodiments of the invention may be devised without departing from the basic scope thereof. The scope of the invention is determined by the claims that will follows in the complete application. The invention is not limited to the described embodiments, versions or examples, which are included to enable a person having ordinary skill in the art to make and use the invention when combined with information and knowledge available to the person having ordinary skill in the art.

### Advantages of the Present Invention

The proposed system enables to negligate the chance of counterfeit notes being feed or dispense from the ATM machine.

The proposed system will put the counterfeited notes out of circulation periodically.

The proposed system has positive impact on the economy.

I claim:

1. A device for currency genuineness detection, the device comprising:
at least one currency inlet slot;
at least one currency exiting slot;
a memory having a set of executable instructions, wherein the execution of said set of instructions by one or more processors causes said one or more processors to:
scan a currency received at the at least one currency inlet slot to detect genuineness of said scanned currency; and
exit, if said scanned currency is genuine, through the at least one currency exiting slot; or
separate, if said scanned currency is not genuine, said scanned currency into a collector.

2. The device as claimed in claim 1, wherein said device is configured before the dispensing mechanism of a cash withdrawal machine or of an automated cash chest counter.

3. The device as claimed in claim 2, wherein said device is configured such that, if said scanned currency is not genuine, the cash withdrawal machine or the automated cash chest counter do not get activated to perform one or more functions.

4. The device as claimed in claim 1, wherein said device includes a plurality of rollers directly connected to a mechanical driving means to turn said rollers functioning to draw said currency through said at least one currency inlet slot and exit through said at least one currency exiting slot.

5. The device as claimed in claim 1, wherein said genuineness of said scanned currency is detected by scanning a plurality of characteristics associated with said currency, wherein said plurality of scanned characteristics are compared with a pre-determined characteristic of a genuine currency.

6. The device as claimed in claim 6, wherein said pre-determined characteristic of said genuine currency are selected at least from observe through register, optically variable ink (OVI), latent image, identification mark, water mark, intaglio printing, security thread, and micro lettering.

7. The device as claimed in claim 1, wherein said device is capable of scanning all sections on top and bottom of said currency to detect said numbers.

8. The device as claimed in claim 1, wherein said device is designed specifically to accommodate varying sizes of currency utilized worldwide.

9. The device as claimed in claim 1, wherein said device functions to convert said numbers into digitized form functioning to increase speed of character recognition.

10. The device as claimed in claim 1, wherein said device comprises at least one detector selected from the group consisting of: optical, magnetic, electrical conductivity, capacitive, and mechanical sensors, for scanning the received currency.

11. The device as claimed in claim 1, wherein the said device comprised at least an image capturing device to capture an image of the operator and/or the customer.

12. The device as claimed in claim 1, the said image captured by the image capturing device will be sent to bank server with ATM ID for future reference.
